(19) United States
(12) Patent Application Publication
(10) Pub. No.: US 2024/0417283 A1
(43) Pub. Date: Dec. 19, 2024

(54) WATER TREATMENT DEVICE BASED ON MICRO-NANO BUBBLE TECHNOLOGY

(71) Applicants: Chongqing Academy of Eco-environmental sciences, Chongqing (CN); Chongqing Institute of Green and Intelligent Technology, Chinese Academy of Sciences, Chongqing (CN)

(72) Inventors: Li FENG, Chongqing (CN); Weiling LIAO, Chongqing (CN); Yong ZHANG, Chongqing (CN); Lei FENG, Chongqing (CN)

(73) Assignees: Chongqing Academy of Eco-environmental sciences, Chongqing (CN); Chongqing Institute of Green and Intelligent Technology, Chinese Academy of Sciences, Chongqing (CN)

(21) Appl. No.: 18/531,740

(22) Filed: Dec. 7, 2023

(30) Foreign Application Priority Data
Jun. 15, 2023 (CN) 202310710951.7

(51) Int. Cl. C02F 1/24; B01D 17/02; B03D 1/14

(52) U.S. Cl. CPC C02F 1/24; B01D 17/0205; B03D 1/1431; B03D 1/1462; B03D 1/1468; B03D 1/1487; B03D 2201/02; B03D 2203/008; C02F 2201/003

(57) ABSTRACT

A water treatment device based on micro-nano bubble technology includes the micro-nano bubble generation device and the sewage tank, the sewage tank is also installed with water surface sewage collection mechanism and water surface sewage cleaning mechanism, the water surface sewage collection mechanism includes the pushing plate and the first transmission component, the pushing plate and the sewage tank are slidingly connected, and the pushing plate is also fixedly connected to the limit connecting rod, the water surface sewage cleaning mechanism includes the cleaning sieve plate and the sewage collecting box, and the cleaning sieve plate is vertically arranged inside the sewage tank, and the sewage tank is fixedly connected with the hinged table, the hinged table is connected with the first rotating shaft and the rear wall of the sewage tank is also equipped with the second transmission component.

### CROSS REFERENCE TO THE RELATED APPLICATIONS

This application is based upon and claims priority to Chinese Patent Application No. 202310710951.7, filed on Jun. 15, 2023, the entire contents of which are incorporated herein by reference.

### TECHNICAL FIELD

The invention belongs to the field of sewage treatment technology, and specifically relates to a water treatment device based on micro-nano bubble technology.

### BACKGROUND

Sewage treatment is an important part of environmental governance. The purification and impurity removal of water resources is related to people's daily life, work, and production operations. With the progress of science and technology, micro-nano bubble technology has been applied to sewage treatment. Micro-nano bubble technology introduces micro-nano bubbles into sewage through a micro-nano bubble technology generating device and uses micro-nano bubbles to drive impurities in sewage to float to the water surface, thus achieving the impurity removal effect of sewage.

Although the impurities in sewage can be separated and removed by micro-nano bubble technology, the impurities still float above the liquid level, which is not easy to clean up, therefore, we propose a water treatment device based on micro-nano bubble technology.

### SUMMARY

The purpose of the present invention is to provide a water treatment device based on micro-nano bubble technology. By setting up a water surface sewage collection mechanism, the impurities floating on the water surface can be pushed to the left and right sides of the sewage tank, and then the impurities concentrated on the left and right sides of the sewage tank are cleaned by the water surface sewage cleaning mechanism, so as to conveniently remove the impurities floating on the liquid level.

In order to achieve the above technical purposes, the technical scheme adopted by the invention is as follows:
A water treatment device based on micro-nano bubble technology includes a micro-nano bubble generation device and a sewage tank, the micro-nano bubble generation device pipeline is connected with an outlet pipe extending to the lower end of the sewage tank, the sewage tank is also equipped with an inlet pipe and a drainage pipe, the sewage tank is also equipped with a water surface sewage collection mechanism and a water surface sewage cleaning mechanism;
The water surface sewage collection mechanism includes two pushing plates and the first transmission component, the two pushing plates are arranged side by side in the middle of the upper end of the sewage tank and slidingly connected with the sewage tank, the front and rear ends of the two pushing plates are also fixedly connected with a limit connecting rod matching the upper wall of the sewage tank, the first transmission component is fixedly installed on the front wall of the sewage tank, and it is used to push the two limit connecting rods on the front side away from or close to each other;
The water surface sewage cleaning mechanism includes two cleaning sieve plates and two sewage collecting boxes, the two cleaning sieve plates are vertically arranged at the left and right ends of the sewage tank, the left and right sides of the upper end of the sewage tank, are fixedly connected with hinged tables, the two hinged tables are rotationally connected with the first rotating shaft, the two cleaning sieve plates are respectively fixedly connected with the two first rotating shafts, the two sewage collecting boxes are fixedly installed on the outer walls of the left and right ends of the sewage tank, the upper-end width of the sewage collecting box matches the width of the cleaning sieve plate, the second transmission component is also arranged on the rear wall of the sewage tank, the second transmission component is used to drive the two first rotating shafts to rotate reversely with each other;
The first transmission component includes a biaxial motor, a screw, and a connecting plate, the number of screws is two and is fixedly connected with the output shafts on both sides of the biaxial motor respectively, the thread rotation directions of the two screws are opposite, the number of connecting plates is two and is fixedly connected with the two limit connecting rods on the front side respectively, the two connecting plates are respectively connected with the two screws by thread rotation.

The second transmission component includes the servo motor, active gear, transmission gear, transmission pulley, and driven pulley, the output shaft of the servo motor is fixedly connected with the active gear, the rear wall of the sewage tank is rotated and connected with two left and right sets of the two-second rotating shaft, the number of the transmission gears is two and fixedly connected with the two-second rotating shafts respectively, the two transmission gears mesh with each other, the active gear mesh with one of the transmission gears, the number of the transmission pulleys is two and fixedly connected with the two-second rotating shafts respectively, the number of driven pulleys is two and is fixedly connected to the ends of the two first rotating shafts respectively, and the belt drive between transmission pulleys and driven pulleys on the same side is connected.

The ratio of tooth number of the transmission gears and the rotating gears is not less than 2.

The extension lengths of the two limit connecting rods on the left and right sides of the pushing plate are matched with the width of the cleaning sieve plate.

The upper ends of the sewage collecting box on the left and right sides are fixed with the first right-angle cover, and the upper ends of the two pushing plates on the left and right sides are fixed with the second right-angle cover matching the limit connecting rod, the first right-angle cover on the same side matches the second right-angle cover.

Several plastic patches are also installed on the lower side of the first right-angle cover on the left and right sides, the cleaning sieve plate is made of a thin-walled iron sheet and coated with anti-corrosion and anti-rust coating.

The inlet pipe is also equipped with a filter, the inlet pipe and the drainage pipe are on and off through the valve.

The first transmission component and the second transmission component also include a protective shell.

When the device is used, the sewage is fed into through the inlet pipe, after the sewage is filled with the sewage tank, the micro-nano bubble generation device is started, the micro-nano bubbles enter the sewage tank through the outlet pipe, and the impurities in the water are adsorbed by the micro-nano bubbles, the impurities float to the surface of the water, so that the sewage is purified and the quality of the sewage is significantly improved, when a large amount of impurities are accumulated on the sewage surface, the water surface sewage collection mechanism is started, through two pushing plates, the impurities on the sewage surface are pushed to the left and right sides of the sewage tank, through the synchronous upturn of two cleaning sieve plates, the concentrated impurities on the left and right sides are taken out of the sewage tank until the cleaning sieve plate is turned over to the sewage collection box, and the impurities can fall into the sewage collection box; after the impurity cleaning is completed, the water surface sewage collection mechanism and the water surface sewage cleaning mechanism are controlled back to the initial state, and then the drainage pipe is opened to discharge the treated water.

### BRIEF DESCRIPTION OF THE DRAWINGS

The present invention can be further explained by the non-restricted embodiment given in the attached diagram.

FIG. 1 is the structural schematic diagram of Embodiment. 1 in the initial state of the water treatment device based on micro-nano bubble technology;

FIG. 2 is the structural schematic diagram of Embodiment. 1 in the initial state of the invention;

FIG. 3 is the structural schematic diagram of the working state structure of the water surface sewage collecting mechanism and the water surface sewage cleaning mechanism of the Embodiment. 1 of the invention;

FIG. 4 is the structural schematic diagram of the Embodiment. 2 in the initial state of the invention;

FIG. 5 is the schematic diagram of the working state structure of the water surface sewage collecting mechanism and the water surface cleaning sewage mechanism of the Embodiment. 2 of the invention;

FIG. 6 is the structural schematic diagram of the Embodiment. 3 of the invention;

The main component symbols are described as follows:

Embodiment. 1: micro-nano bubble generating device 100, sewage tank 101, outlet pipe 102, inlet pipe 103, drainage pipe 104, pushing plate 105, limiting connecting rod 106, cleaning sieve plate 107, sewage collecting box 108, hinged table 109, first rotating shaft 110, biaxial motor 111, screw 112, connecting plate 113, servo motor 114, active gear 115, transmission gear 116, transmission pulley 117, driven pulley 118, second rotating shaft 119;

Embodiment. 2: the first right-angle cover 200, the second right-angle cover 201, plastic patch 202;

Embodiment. 3: filter 300, protective shell 301.

### DETAILED DESCRIPTION OF THE EMBODIMENTS

In order to enable technicians in this field to better understand the invention, the technical scheme of the present invention is further explained in combination with the attached drawings and embodiments.

### Embodiment. 1

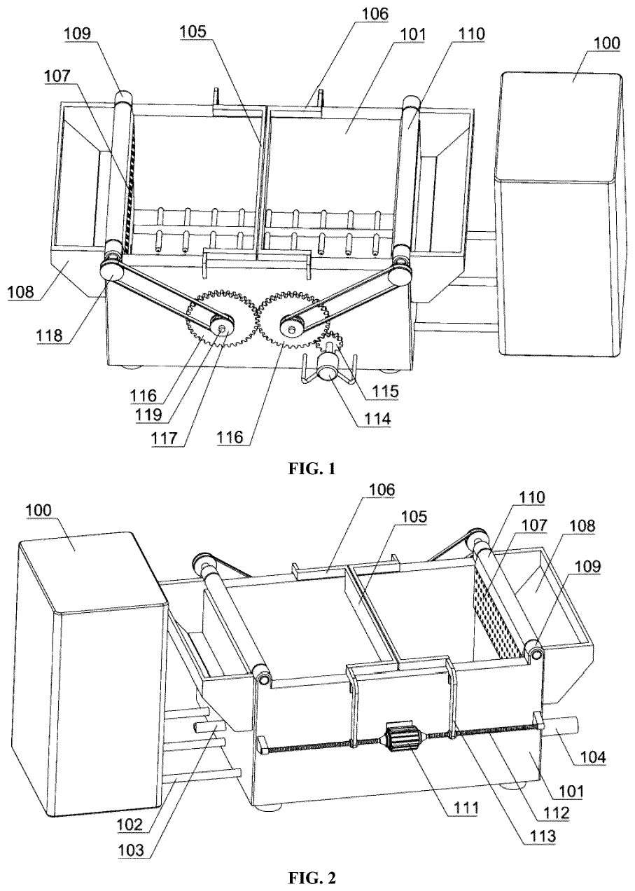

As shown in FIGS. 1 to 3, a water treatment device based on micro-nano bubble technology includes a micro-nano bubble generation device 100 and a sewage tank 101, the micro-nano bubble generation device 100 pipeline is connected with an outlet pipe 102 extending to the lower end of the sewage tank 101, the sewage tank 101 is also equipped with an inlet pipe 103 and a drainage pipe 104, the sewage tank 101 is also equipped with a water surface sewage collection mechanism and a water surface sewage cleaning mechanism;
The water surface sewage collection mechanism includes two pushing plates 105 and the first transmission component, the two pushing plates 105 are arranged side by side in the middle of the upper end of the sewage tank 101 and slidingly connected with the sewage tank 101, the front and rear ends of the two pusher plates 105 are also fixedly connected with the limit connecting rod 106 matched with the upper wall of the sewage tank 101, the first transmission component is fixedly installed in the front wall of the sewage tank 101, and the first transmission component is used to push the two limiting connecting rods 106 on the front side away from each other or close to each other;
The first transmission component includes a biaxial motor 111, a screw 112, and a connecting plate 113, the number of screw 111 is two and is fixedly connected with the output shaft on both sides of the biaxial motor 110 respectively, the thread rotation directions of the two screws 111 are opposite, the number of connecting plates 113 is two and is fixedly connected with the two limit connecting rods 106 on the front side respectively, the two connecting plates 113 are respectively connected with the two screws 111 by thread rotation;
The water surface sewage cleaning mechanism includes two cleaning sieve plates 107 and two sewage collecting boxes 108, the two cleaning sieve plates 107 are vertically arranged at the left and right ends of the sewage tank 101 respectively, and the hinged table 109 is fixedly connected on both sides of the upper end of the sewage tank 101, the two hinged tables 109 are rotationally connected with the first rotation shaft 110, the two cleaning sieve plates 107 are fixedly connected with the two first rotation shafts 110 respectively, the two sewage collecting boxes 108 are fixedly installed on the outer walls of the left and right ends of the sewage tank 101 respectively, the width of the upper end of the collecting box 108 matches the width of the cleaning sieve plate 107, the second transmission component is also set on the rear wall of the 101 of the sewage tank, the second transmission component is used to drive the two first rotation shafts 110 to rotate reversely with each other.

The second transmission component includes a servo motor 114, a driving gear 115, a transmission gear 116, a transmission pulley 117, and a driven pulley 118, the output shaft of the servo motor 114 is fixedly connected to the driving gear 115, and the rear wall of the sewage tank 101 is rotated and connected with two-second rotating shafts 119, the number of transmission gears 116 is two and is fixedly connected to two-second rotating shafts 119, the two transmission gears 116 are meshing with each other, and the driving gear 115 is meshing with one of the transmission gears 116, the number of transmission pulley 117 is two and is fixedly connected with two-second rotating shafts 119 respectively, the number of driven pulley 118 is two and is fixedly connected with the 110 ends of the two first rotating shafts respectively, the belt drive between the transmission pulley 117 and the driven pulley 118 on the same side is connected.

The sewage enters the sewage tank 101 through the inlet pipe 103, and the micro-nano bubble generating device is used to generate micro-nano bubbles, the sewage is treated by introducing the outlet pipe 102 into the sewage tank 101, and the impurities in the water are adsorbed by the micro-nano bubbles, so that the impurities float to the water surface, and the sewage is purified; the water surface sewage collecting mechanism is used to concentrate the impurities on the water surface, and the water surface sewage cleaning mechanism is used to clean up the concentrated impurities; the working principle of the water surface pollution collecting mechanism is as follows: the two screws 112 can be rotated by starting the two biaxial motors 111 of the first transmission component, because the two screws 112 are respectively connected with the two connecting plates 113 by thread rotation and the threads are rotated in the opposite direction, so when the two screw 112 rotates, the two connecting plates 113 can be separated from each other, and because the two connecting plates 113 are respectively fixed with the two limit connecting rods 106 on the front side, so when the two connecting plates 113 are separated from each other, the two pushing plates 105 can be driven away from each other, the two pushing plates 105 move from the middle of the sewage tank 101 to the left and right sides respectively, so that the impurities on the water surface are concentrated to the left and right sides of the sewage tank 101 respectively; the working principle of the water surface sewage cleaning mechanism is as follows: the servo motor 114 of the second transmission component is started, and it is controlled by the servo system, when the servo motor receives one pulse, it will rotate the angle corresponding to one pulse, so as to accurately control the rotation number, rotation direction and rotation angle of the servo motor, after the servo motor 114 is started, the driving gear 115 drives one of the transmission gears 116 to rotate, because the two transmission gears 116 are meshed, the rotation directions of the two transmission gears 116 are opposite, at the same time, under the transmission of the driven pulley 117 and the driven pulley 118, the two first rotation shafts 110 can rotate in the opposite direction, so that the cleaning sieve plate 107 on the left and right sides flips up synchronously, and the impurities concentrated on the left and right sides of the sewage tank 101 are taken out of the sewage tank 101 until the cleaning sieve plate 107 on the left and right sides rotates to the sewage collection box 108 on the left and right sides respectively, after controlling the servo motor 114 to stop rotation, the impurities of the cleaning sieve plate 107 can fall into the sewage collection box 108;
In the initial state of the present device, as shown in FIG. 1 and FIG. 2, the two pusher plates 105 of the water surface sewage collection mechanism are arranged side by side and located in the middle of the sewage tank 101, and the two cleaning sieve plates 107 of the water surface sewage cleaning mechanism are arranged side by side with the wall shear of the sewage tank 101 in a vertical downward state;

The following steps are included in the use of the device:
S1, in the initial state of the device, the sewage is introduced through the inlet pipe 103, after the sewage is filled with the sewage tank 101, the micro-nano bubble generating device 100 is started, and the micro-nano bubbles enter the sewage tank 101 through the outlet pipe 102;
S2, the impurities in the water are adsorbed by micro-nano bubbles, and the impurities are floated to the water surface so that the sewage is purified;
S3, the water quality has been significantly improved, when a large number of impurities are accumulated on the sewage surface, the water surface sewage collection mechanism is started, and the impurities on the sewage surface are pushed and concentrated on the left and right sides of the sewage tank 101 through two pusher plates 105;
S4, after the impurities of the sewage water surface are concentrated on the left and right sides of the sewage tank 101, the water surface sewage cleaning mechanism is started, and the impurities concentrated on the left and right sides are taken out of the sewage tank 101 through the simultaneous flipping of the two cleaning sieve plates 107 until the cleaning sieve plate 107 is turned over to the sewage collection box 108, the impurities can fall into the sewage collection box 108, as shown in FIG. 3;
S5, after the impurity cleaning is completed, the water surface sewage collection mechanism and the water surface sewage cleaning mechanism are controlled back to the initial state, and then the drainage pipe 104 is opened to discharge the treated water.

As a further optimization of this embodiment, the ratio of tooth number of the transmission gear and rotating gear 115 is not less than 2, this setting method can slow down the rotation speed of the second rotating shaft 119 and avoid the inertial impact caused by excessive rotation.

### Embodiment. 2

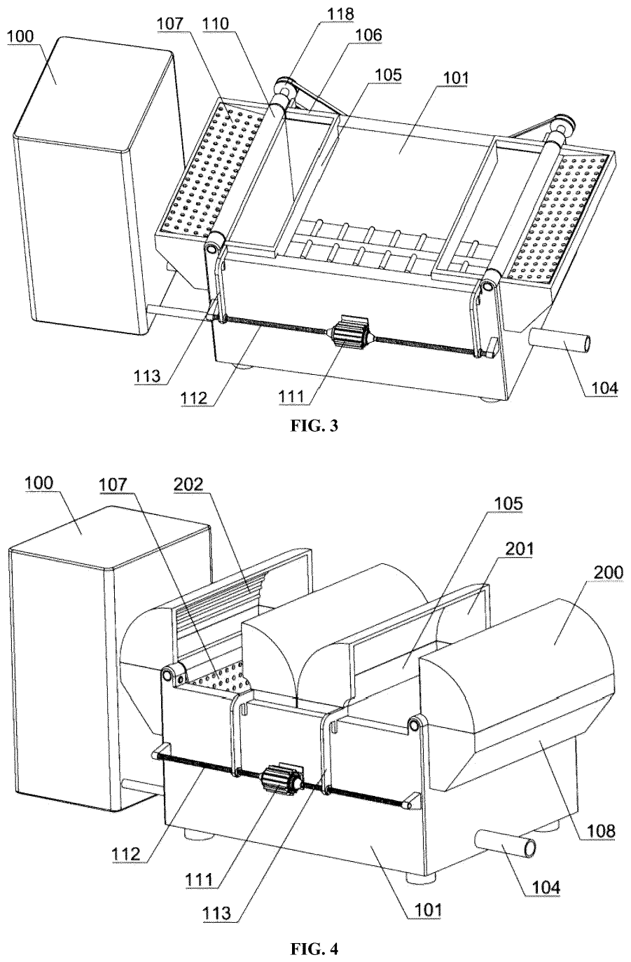

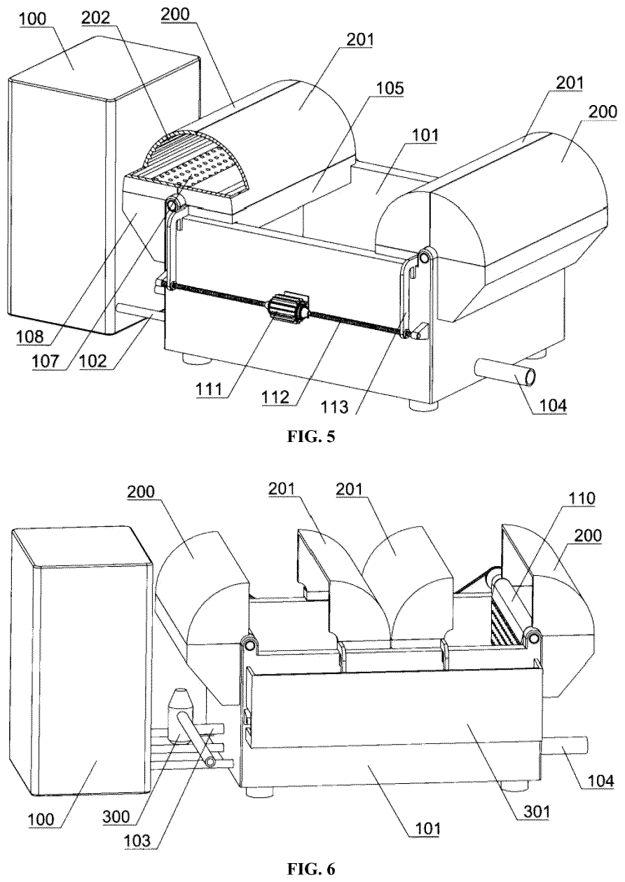

On the basis of the Embodiment. 2, a further optimization is made, as shown in FIGS. 4 to 5, the extension length of the two limit connecting rods 106 of the pusher plate 105 on the left and right sides matches the width of the cleaning sieve plate 107;
The upper ends of the sewage collecting box 108 on the left and right sides are fixed with the first right-angle cover 200, and the upper ends of the two pushing plates 105 on the left and right sides are fixed with the second right-angle cover 201 matching the limit connecting rod 106, and the first right-angle cover 200 on the same side matches the second right-angle cover 201.

The inner wall of the lower side of the first right-angle cover 200 on the left and right sides is also equipped with a number of plastic patches 202, the cleaning sieve plate 107 is made of thin-walled iron sheet and coated with anti-corrosion and anti-rust coating.

The extension length of the limit connecting rod 106 is matched with the width of the cleaning sieve plate 107, which can make the limit connecting rod 106 gradually close to the hinged table 109 when the two pushing plates 105 are far away from each other and the impurities are concentrated on the left and right sides of the sewage tank 101 until it is offset with the hinged table 109, the pushing plate 105 will no longer push the impurities, at this time, the concentration range of the impurities will match the cleaning sieve plate 107 so that when the cleaning sieve plate 107 rotates and cleans the dirt, it can bring all the concentrated impurities out;
The first right-angle cover 200 and the second right-angle cover 201 are set, after the two pushing plates 105 push the impurities, the first right-angle cover 200 and the second right-angle cover 201 on the right side will be merged, as shown in FIG. 5 so that when the two cleaning sieve plates 107 rotate and clean the dirt, the enclosed space of the merger of the right-angle cover 200 and the second right-angle cover 201 avoids the splash of impurities due to centrifugal force;
The cleaning sieve plate 107 is made of thin-walled iron sheet and coated with anti-corrosion and anti-rust coating, which can avoid the corrosion and erosion of the cleaning sieve plate 107 in sewage, at the same time, when the cleaning sieve plate 107 rotates to the lower side wall of the first right-angle cover 200, because the cleaning sieve plate 107 is thin-walled iron sheet, when the cleaning sieve plate 107 rotates to connect with the plastic patch 202, it can deform, after separating from the plastic patch 202, it will rebound, so that the cleaning sieve plate 107 can deform and rebound during the rotation of the inner wall of the lower side of the first right-angle cover 200, it can further shake the impurities brought out by the cleaning sieve plate 107 into the sewage collection box 108.

### Embodiment. 3

Based on the Embodiment. 2, a further functional optimization is carried out, as shown in FIG. 6, the inlet pipe 103 is also equipped with a filter 300, and the inlet pipe 103 and the drainage pipe 104 are connected and disconnected through the valve, the first transmission component and the second transmission component also include a protective shell 301.

The filter 300 is set up, which can make the preliminary filtration before the sewage enters the sewage tank 101, and filter out the large volume of debris; when the sewage is introduced, the valve of the inlet pipe 103 is opened, the valve of the drainage pipe 104 is closed, and when the treated sewage is discharged, the valve of the drainage pipe 104 is opened; the protective shell 301 is used to protect the first transmission component and the second transmission component to avoid damage due to collision.

The embodiments just illustrate the principle of the invention and its efficacy, and are not used to restrict the invention. Anyone familiar with this technology can modify or change the above embodiments without violating the spirit and scope of the invention. Therefore, all equivalent modifications or changes made by a person with general knowledge in the technical field, without departing from the spirit and technical ideas revealed by the invention, shall still be covered by the claims of the invention.

What is claimed is:

1. A water treatment device based on micro-nano bubble technology, comprising a micro-nano bubble generation device and a sewage tank, a micro-nano bubble generation device pipeline is connected with an outlet pipe extending to a lower end of the sewage tank, the sewage tank is further equipped with an inlet pipe and a drainage pipe, the sewage tank is further equipped with a water surface sewage collection mechanism and a water surface sewage cleaning mechanism, wherein
the water surface sewage collection mechanism comprises two pushing plates and a first transmission component, the two pushing plates are arranged side by side in a middle of an upper end of the sewage tank and slidingly connected with the sewage tank, front and rear ends of the two pushing plates are further fixedly connected with limit connecting rod, wherein the limit connecting rod matches an upper wall of the sewage tank, the first transmission component is fixedly installed on a front wall of the sewage tank, and the first transmission component is configured to push the two limit connecting rods on the front side away from or close to each other;
the water surface sewage cleaning mechanism comprises two cleaning sieve plates and two sewage collecting boxes, the two cleaning sieve plates are vertically arranged at left and right ends of the sewage tank, and left and right sides of the upper end of the sewage tank are fixedly connected with hinged tables, the two hinged tables are rotationally connected with first rotating shaft, the two cleaning sieve plates are respectively fixedly connected with the two first rotating shafts, the two sewage collecting boxes are fixedly installed on outer walls of the left and right ends of the sewage tank, an upper-end width of the sewage collecting box matches a width of the cleaning sieve plate, a second transmission component is further arranged on a rear wall of the sewage tank, the second transmission component is configured to drive the two first rotating shafts to rotate reversely with each other.

2. The water treatment device based on the micro-nano bubble technology according to claim 1, wherein the first transmission component comprises a biaxial motor, a screw, and a connecting plate,
number of screws is two and the two screws are fixedly connected with output shafts on both sides of the biaxial motor respectively, thread rotation directions of the two screws are opposite, number of connecting plates is two and the two connecting plates are fixedly connected with the two limit connecting rods on the front side respectively, the two connecting plates are respectively connected with the two screws by thread rotation.

3. The water treatment device based on the micro-nano bubble technology according to claim 2, wherein the second transmission component comprises servo motor, active gear, transmission gear, transmission pulley, and driven pulley,
an output shaft of the servo motor is fixedly connected with the active gear, a rear side wall of the sewage tank is rotated and connected with two left and right sets of two-second rotating shaft, number of the transmission gears is two and the two transmission gears are fixedly connected with the two-second rotating shafts respectively,
the two transmission gears mesh with each other, the active gear mesh with one of the two transmission gears, number of the transmission pulleys is two and the two transmission pulleys are fixedly connected with the two-second rotating shafts respectively, number of driven pulleys is two and the two driven pulleys are fixedly connected to ends of the two first rotating shafts respectively, and belt drive is configured between the two transmission pulleys and the two driven pulleys on the same side.

4. The water treatment device based on the micro-nano bubble technology according to claim 2, wherein a ratio of a tooth number of the two transmission gears and rotating gears is greater than or equal to 2.

5. The water treatment device based on the micro-nano bubble technology according to claim 3, wherein extension lengths of the two limit connecting rods on left and right sides of the pushing plate are matched with the width of the cleaning sieve plate.

6. The water treatment device based on the micro-nano bubble technology according to claim 5, wherein upper ends of the sewage collecting box on the left and right sides are fixed with a first right-angle cover, and upper ends of the two pushing plates on the left and right sides are fixed with a second right-angle cover, wherein the second right-angle cover matches the limit connecting rod, the first right-angle cover on the same side matches the second right-angle cover.

7. The water treatment device based on the micro-nano bubble technology according to claim 6, wherein a plurality of plastic patches are further installed on a lower side of the first right-angle cover on the left and right sides, and the cleaning sieve plate is made of a thin-walled iron sheet and coated with anti-corrosion and anti-rust coating.

8. The water treatment device based on the micro-nano bubble technology according to claim 5, wherein the inlet pipe is further equipped with a filter, the inlet pipe and the drainage pipe are on and off through a valve.

9. The water treatment device based on the micro-nano bubble technology according to claim 5, wherein the first transmission component and the second transmission component further comprise a protective shell.
